(19) United States
(12) Patent Application Publication
(10) Pub. No.: US 2002/0183072 A1
(43) Pub. Date: Dec. 5, 2002

(54) BeyondguideTM method and system

(76) Inventors: Galia Steinbach, Potomac, MD (US); Yechiam Halevy, N. Bethesda, MD (US); Yuval Rabin, Rockville, MD (US)

Correspondence Address: Supervisor, Patent Prosecution Services, PIPER RUDNICK LLP, 1200 Nineteenth Street, N.W., Washington, DC, 20036-2412, US

(21) Appl. No.: 10/123,218

(22) Filed: Apr. 17, 2002

Related U.S. Application Data
(60) Provisional application No. 60/283,929, filed on Apr. 17, 2001.

(51) Int. Cl. H04M 3/42; H04Q 7/20

(52) U.S. Cl. 455/456; 455/414

(57) ABSTRACT

A method and system, referred to in one variation as “BeyondGuide™,” for delivering dynamic and personalized experiences to remote devices, including cellular telephones, thus providing the ability to move about a city's tourist attractions while receiving personalized content, including original and reenacted audio. The system includes capability for access via a variety of remote devices, including cellular telephones, personal data assistants, and personal computers, a tour engine that is capable of accessing a repository of information linked to geographical information, allowing tailoring of information to geographical location, a geographical positioning determination component for locating the remote device, content handling tools, including software, connection to content providers, and connection to support centers, such as call centers.

This application claims priority from U.S. Provisional Patent Application Serial No. 60/283,929 filed Apr. 17, 2001. The entirety of that provisional patent application is incorporated herein by reference.

### BACKGROUND OF THE INVENTION

1. Field of the Invention

The present invention relates to audio guided tours, and in particular to a method and system for providing a user variable and customizable audio tour via a cellular telephone or other communication device using speech recognition.

2. Background of the Technology

There are a number of existing guided tour technologies, including the following:

Printed tour guides. These guides are static, with delivery designed for everyone and not easily customizable to individuals.

Printed guidebooks and maps (e.g., Lonely Planet, Fodor's). These guides provide travelers with basic information on a city's attractions and destinations. While these resources often provide suggestions on where to dine and stay, they are infrequently updated with new information. Furthermore, the information provided to travelers is just that, information. It is not customized to the traveler's interests or behaviors, and its static format requires travelers to search for the information that they desire.

Location-based information providers. This guide information includes interactive delivery designed for a group. Recently, software products have been introduced that allow travel information to be viewed on personal digital assistants (PDAs) (e.g., wCities, AvantGo, Vindigo and10Best.com). These products provide users with basic, brief information on a city's sites, restaurants, nightclubs, special events and movies. Unlike printed tour guides, these products do allow customers to frequently download updated versions off the Web onto their PDAs. Location-based products also allow customers to search for information by simple variables, such as location or type of restaurant, and provide directions to different locations. However, these simple searches limit customization of information to a user's location and obvious preferences (e.g., type of cuisine). In addition, data is not delivered in an interactive format; users must still search for the information they are seeking. Further, since it is text that is delivered, there is no “experience;” there is a big difference between reading and listening.

Web-based information. This guide information includes interactive delivery designed for an individual. Travelers can certainly access information on travel destinations from the Web. This information is up-to-date and can even be personalized to the specific interests of a traveler. One problem with Web-based travel resources is that the content, while personalized, is delivered before or after the actual travel experience. There is no content delivery during the trip, and a Web site does not deliver an experience. As the wireless Web becomes more pervasive, this group of products and services may evolve into location-based information providers (as above)—with their same limitations.

Live tour guides. This guide information includes immersive delivery designed for a group.

Live tour guides provide travelers with real-time information as they visit landmarks and attractions. Some tours even customize the information being provided to a select group of tourists (e.g., history buffs, families with kids), but not to an individual's personal preferences and behaviors. Live tours actually deliver content to the traveler so they don't have to search for it themselves. Yet, while these tours allow guests to ask questions and get information as they go along, tours are rarely modified based on a person's requests. Individual travelers are forced to tour at the pace and will of the group and are subject to the limitations of the guide (e.g., knowledge level, accent).

Museum audio guides. This guide information includes interactive, immersive delivery designed for everyone. Audio systems offered to museumgoers are designed to feed them information as they visit exhibits. Typically, users do not have to search for information, though they may be required to enter numbers into the audio device they carry. These audio systems allow users to walk around exhibits at their own pace, viewing items in the order they choose. However, the audio information provided through these devices is the same for anyone using the product; the information is not tailored for any individual or group. Furthermore, content is neither live nor updated frequently (so current events cannot be promoted), and technological limitations prevent these devices from delivering content on, for example, a citywide basis.

Living history museums. This guide information includes interactive, immersive delivery designed for a group. A living history museum is a location (outdoor or indoor) that attempts to educate its visitors by reenacting history. In these locations, like Colonial Williamsburg, visitors can interact with “interpreters,” who are paid to dress and act as though they are in an historic time. These museums clearly deliver content in an interactive way, allowing visitors to experience history firsthand. However, the reenactment is only customized to the dedicated theme of the location and historic period. A living history museum cannot be personalized to individual preferences and behaviors. Additionally, it is extremely expensive to maintain a living history museum, making it an impractical way to experience all but a few special sites.

There is currently no direct competitor in the marketplace that delivers personalized and automated tour and other services. There are many indirect service providers (e.g., guidebooks, PDA information providers, museum audio tours, Web sites, tour packagers, live guides), but none combines all four of the following distinguishing characteristics: 1) storytelling, through the use of rich, unique content; 2) mobile delivery, using everyday wireless devices (e.g., cellular telephones); 3) on-site experience, so everything takes place in “actual” reality; and 4) live, individualized content that makes each user's experience unique—based on who he is, where he is, and when he is there.

There is an unmet need to provide audio tours via remote devices, such as cellular telephones, using automated features, such as automatic locating of the user of the device and interactive voice response (IVR) or other automated interaction.

### SUMMARY OF THE INVENTION

The present invention, referred to as “BeyondGuide™” includes a method and system for delivering dynamic and personalized experiences over mobile telephones and other similar devices, providing users with the ability to move about a city's tourist attractions while receiving personalized content, including original and reenacted audio. BeyondGuide™ is a personal travel guide that informs and entertains tourists based on their interests and preferences.

The present invention provides the exceptional travel experience in part because it provides users with unique, high-quality content customized to their interests and their behavior. The system tailors each experience based on the information a customer has requested, allowing travelers to visit only where they want, at their own pace. Furthermore, the present invention delivers content on site in real-time.

In an embodiment of the present invention, the BeyondGuide™ experience provides a number of advantages, including the following: 1) interactive, empowering travelers to control their own tours, letting them explore what they want, at their own pace; 2) immersive, combining the actual environment of a given Point Of Interest (POI) with entertaining facts, anecdotes and reenactments of historic events that have taken place there (e.g., standing on the steps of the Lincoln Memorial listening to Martin Luther King's “I Have a Dream” speech); and 3) individualized to the preferences and behavior of a single traveler at a particular location on a given time and day.

In one embodiment, BeyondGuide™ offers citywide audio tours via remote devices, such as mobile telephones, in contact with a server or servers. This service is similar to the audio tours delivered today in many museums, except that it is personalized, interactive and offers dynamic, non-linear content. Using speech recognition, users are able to interact with the system, navigating their tour based on what they want to see and hear. Other embodiments, utilizing higher bandwidth mobile transmissions, offer multimedia content that enhances a traveler's experience. In addition, some embodiments of BeyondGuide™ use automated positioning technologies to better guide tourists around a city, anticipate what content they might want to hear, and offer location-based features, such as walking directions. Services in accordance with the present invention are providable on any mobile technology platform that can support real-time interactive exchange of multimedia data.

In an embodiment of the present invention, tourists activate the service by dialing the BeyondGuide™ toll-free number on their mobile telephones and by providing, for example, a personal identification number (PIN) for access to services. They interact with the service through a speech recognition system, indicating where they are and what menu choices they want to hear. Content is related directly to individual points of interest and also coordinated across themes, such as the Civil War, Scandals, Walk with the Presidents, and interviews with local persons of interest. The more the tourist uses the services, the more personalized it becomes. BeyondGuide™ includes sophisticated software that analyzes an individual's requests for content and then promotes or demotes content choices based on the user's indicated preferences. In some embodiments, users are able to input their preferences and interests through the Internet before taking their tour, leading to a more highly personalized tour.

Expanded service in additional embodiments of the present invention include other forms of content (e.g., live video) delivered across multiple wireless platforms.

Additional advantages and novel features of the invention are set forth in the attachments to this summary, and in part will become more apparent to those skilled in the art upon examination of the following or upon learning by practice of the invention.

### BRIEF DESCRIPTION OF THE FIGURES

In the drawings:

FIG. 1 presents an overview pictogram of system elements in accordance with an embodiment of the present invention;

FIG. 2 is a flow diagram of a method of providing pre-tour interactive information, in accordance with an embodiment of the present invention;

FIG. 3 is a flow diagram of a method of providing interactive information during a tour, in accordance with an embodiment of the present invention; and

FIG. 4 is a flow diagram of a method of providing post-tour interactive information, in accordance with an embodiment of the present invention.

### DETAILED DESCRIPTION

The present invention includes a method and system, referred to in one embodiment as “BeyondGuide™,” for delivering dynamic and personalized experiences to remote devices, including cellular telephones, thus providing the ability to move about a city's tourist attractions while receiving personalized content, including original and reenacted audio. The system includes capability for access via a variety of remote devices, including cellular telephones, personal data assistants, and personal computers, a tour engine that is capable of accessing a repository of information linked to geographical information, allowing tailoring of information to geographical location, a geographical positioning determination component for locating the remote device, content handling tools, including software, connection to content providers, and connection to support centers, such as call centers.

In the wireless arena, technology has yet to be standardized. Wireless application protocol (WAP)-based and I-MODE cellular telephones, PDAs, large screen pagers and other devices present significant restrictions for delivering multimedia content in real time. They offer limited functionality and coverage, and therefore, limited acceptance. Furthermore, it is expected that broadband wireless networks (required for transmission of rich multimedia) will not be widely available for several years. Given this, and to reach as broad of an audience as possible, BeyondGuide™ utilizes cellular telephones as the delivery device in one embodiment of the present invention. However, in an embodiment of the present invention, the the technology and systems are platform-independent.

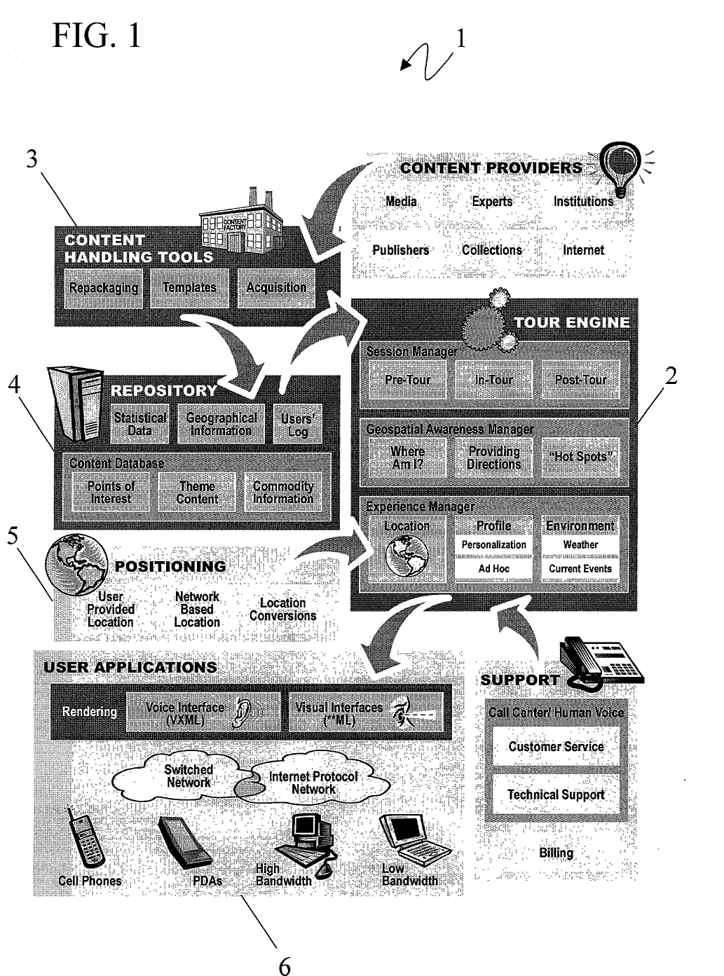

Each of the major components of an embodiment of the present invention are described below and illustrated in FIG. 1.

The system of the present invention 1, referred to in one embodiment, and referred to interchangeably herein, as “BeyondGuide™”, includes a Tour Engine 2, which is composed of or connected to several major components. It has been designed flexibly to enable the rapid integration of evolving technologies. This flexibility is most relevant in the areas of user interface and geo-positioning. The Tour Engine 2 and its connected components include: 1) content handling tools 3; 2) a repository 4; 3) positioning services 5; 4) the tour engine 2; and 5) user applications 6, also referred to interchangeably herein as remote devices. These components comprise or are housed on a server or servers and/or, optionally, are connected via a network or networks, such as the Internet, an intranet, a cellular or other wireless telephone network, or a publicly owned telephone system (POTS). A user (also referred to interchangeably herein as a “tourist”) accesses the server or servers via the user applications or remote devices 6, for example, a cellular telephone, a wired telephone, or other personal communication device, such as a PDA, or high bandwidth or low bandwidth communication terminal, such as a personal computer (PC), minicomputer, mainframe computer, or microcomputer.

The server includes or is coupled to the repository 4, such as or including a database. The server includes, for example, a PC, minicomputer, microcomputer, or mainframe computer.

BeyondGuide™ includes proprietary methodologies and software tools for creating Tour Engine-compliant content. These tools ensure the consistency of the BeyondGuide™ experience—even when it is created by a multitude of content providers in many languages and locations. The Content Handling Tools 3 implement the nature, “hear and feel”, persona, and metaphor of the BeyondGuide™ service.

The system 1 shown in FIG. 1 stores and organizes a tremendous amount of data in its repository 4. These data include: 1) content (points of interest and themes); 2) commodity information; 3) geographical information; 4) users' log; and 5) statistical data.

In order to create a truly unique and exceptional experience, BeyondGuide™ delivers state-of-the-art content. For example, in one embodiment, BeyondGuide™ does not include synthesized voice technologies (text to speech); these do not meet quality requirements for the present invention. Consequently, the Tour Engine database is designed to handle very large volumes of media-rich data. In an embodiment of the present invention, the Tour Engine repository is a standard structure query language (SQL) implementation.

In addition to storing content, the repository 4 also serves as a gateway to externally provided data (e.g., commodity information, geographical information), which may be provided, for example, by content providers 10, coupled to the repository 4 via the network so as to provide content using the content handling tools 3. To any other part of the system 1, the data's actual storage location (internal or external) and format is transparent. The repository 4 provides the requested data units from their respective locations rendered to the required format.

A user log maintained in the system 1 keeps track of each user's actions, such as points-of-interests visited and content segments heard. Using the log file, BeyondGuide™ is able to enhance the ongoing tour (by shifting content based on what has been experienced), the post-trip experience (with follow up content and functionality), and subsequent BeyondGuide™ tours. Additionally, the log serves as one source of statistical information, as described further below.

The present invention continuously gathers and stores statistical data to determine users' preferences and thereby refine the experience. The system monitors how often each point of interest is visited, which content segments are preferred, and how long users listen.

Accurate location information for the tourist or other user is critical. One function of the positioning module is to provide a uniform abstracted location retrieval interface for the Tour Engine, as described further below. The positioning module varies depending on the technology used. This module serves all geo-data related requests, such as vicinity related queries (e.g., nearest restroom or automatic teller machine (ATM), restaurant of certain cuisine, as well as directions to get there).

In one embodiment of the present invention, for use with a user using a mobile remote device, such as a cellular telephone, the Tour Engine system determines where the user is located in order to deliver content appropriate to their location. Location can be expressed in many ways, such as: 1) corner of 16th Street, NW & Pennsylvania Avenue; 2) 1600 Pennsylvania Avenue; or 3) the White House.

In one embodiment, users provide location information to the system verbally and speech recognition software determines their locations. In one embodiment, this feature is referred to as “Where Are You” (WAY). In other embodiments, automatic positioning, such as global positioning system (GPS) tracking, and cellular telephone triangulation, is employed to determine location and thereby enhance the user's experience (e.g., information automatically formatted for location without active user input of the location information).

In one embodiment, a Tour Engine powers the BeyondGuide™ system. This Tour Engine enables the delivery of appropriate content to users. Further, it generates and processes the “intelligence” that allows personalization of each user's experience based on preferences, behavior, weather, time-of-day, season, and other factors.

In an embodiment of the present invention, a Session Manager creates and maintains the user session. In the BeyondGuide™ environment, this is a challenge since a user-session encompasses multiple “network” connections. The continuity of a session can be severely compromised both by connectivity issues inherent to the lower reliability of cellular networks, as well as by native distractions in outdoor environments. The Session Manager offers sophisticated session recovery options to save the tourist from redundant steps and from re-experiencing content.

The Experience Manager is responsible for creating the best possible user experience. In order to achieve exceptional personalization, the Experience Manager continuously considers a user's profile, interests expressed on an ad hoc basis, various environmental variables, and the tourist's physical position. Personalization is the process by which the system refines the user experience (e.g., by delivering targeted content) based on these factors.

In addition to this personalization, BeyondGuide™ allows each tourist to customize the experience. By selecting from various options, such as: 1) type or theme information; 2) level of help with the system (more help vs. less); and 3) level of assistance with navigation directions.

The Geospatial Awareness Manager is the module that confirms and monitors a tourist's physical location. A user's position comes in as a uniform abstracted location from the positioning module, as described above. However, even with the implementation of automatic location technologies, there is some vagueness regarding a tourist's precise position. Therefore, this module combines automatic technologies and tourist dialogues to pinpoint a user's actual location. With embodiments using more sophisticated location technologies, the Geospatial Awareness Manger manages and creates “hotspot” lists. These lists trigger the system when a tourist arrives at a selected POI. BeyondGuide™ thus auto-locates tourists and alerts them to POIs. The Geospatial Awareness Manager also manages walking and driving directions.

In addition to managing the users' locations, the system keeps track of local time. Using this information the user can be presented with time/space relevant information. For example, if there is a parade on the Mall today that starts at 2:00 PM, users would receive an additional message about the parade that would be added to the normal information about the Mall. This message addition would start at 1:00 PM and end a half-hour before the parade ends.

As described above, there is currently no standard wireless delivery platform. For this reason, the present invention provides capability for delivery of content in both visual and audio forms. When requested by the Tour Engine, content is drawn from the repository and “rendered” in the appropriate format.

When a user is traveling on the highway the BeyondGuide™ service determines the user's location. BeyondGuide™ offers a list of POIs that are near to the user. When the user chooses one, the relevant information is presented, along with the opportunity to get further information on the subject. Additionally, the user can be directed to the nearest attractions, as made available by the service.

For example, when a user is traveling on the highway and passes a historical marker BeyondGuide™ will help. The user calls the BeyondGuide™ historical marker service that then determines the user's location. BeyondGuide™ offers a list of markers that are near to the user. When the user chooses one, the text on that marker is recited, along with the opportunity to get further information on the subject. Additionally, the user can be directed to the nearest attractions, restaurants, etc., as made available by the service.

In another example application, the user is in a location with a large format electronic billboard that is running live video or a media presentation. The user calls BeyondGuide™, and after a menu selection, begins to hear the live audio that accompanies the video that is playing on the billboard.

Other features of the present invention will now be discussed.

An embodiment of the present invention provides a portfolio of services that are a traveler's complete “on-the-street” audio companion. These services include the following.

Point of Interest (POI) information is the “story” that describes each point of interest (e.g. landmark, building, memorial) and its historical, cultural and social significance.

Thematic information is presented to unite a series of POIs with a single perspective. For example, “Hail to the Chief” is a tour designed to let travelers see Washington, D.C., as U.S. Presidents did in their day.

Convenience services information (purchased from third parties) provides travelers with basic, useful information, including walking directions, restaurant reviews and referrals, and shopping directories.

Multilingual and multicultural support allows tours to be delivered in multiple languages with different cultural nuances.

Pre- and post-trip services are network-based, such as via the Internet; these services orient travelers to BeyondGuide™ and enable customers to plan an upcoming trip or relive a previous travel experience.

Other embodiments support additional platforms, such as in-vehicle information systems (IVIS). In addition, automatic positioning technologies are included in embodiments of the present invention, which allow use for both indoor and outdoor experiences.

In an embodiment of the present invention, the BeyondGuide™ Tour Engine provides the infrastructure that interprets a user's behavior and delivers back appropriate content. This infrastructure includes the following features: 1) automated and scalable processes translate widely available data into useful information, information into multimedia content, and content into each user's unique experience; and 2) strategic relationships with leading players in sales, distribution, technology and content (referred to interchangeably herein as “content providers”) solidify the channel to services.

In an embodiment of the present invention, users are able to sign up for the service directly through, for example, a website. The user also or optionally calls a toll-free number to become a registered user and pay for the service; the user can also optionally pay for the service online.

An example scenario of use by a user will now be described.

Imagine that you are touring a museum with a hand-held audio device, listening to interesting stories and information about the exhibits. Suddenly, the walls disappear. You are invited outside with your audio companion to explore the city at your own pace, stopping only to learn about the attractions that interest you, listening to the forgotten stories of the city's history and culture. This is the BeyondGuide™ experience: the new convergence of technology, tourism, and entertainment.

The present invention includes infrastructure, technology and processes to deliver a unique experience for business travelers and tourists: independently guided, personalized tours in interesting places around the world. The BeyondGuide™ service intimately introduces each traveler to a city's history, people and landmarks, bringing legendary moments and stories to life.

Simply by using a standard cellular telephone or other remote device, travelers are thus able to hear interesting facts, entertaining anecdotes or reenactments of historic events taking place in the area immediately surrounding them. At any point, a user can obtain more information about the building on the left, the monument on the right, or the way to the best French restaurant nearby. BeyondGuide™ enhances each traveler's experience even further by tailoring content to his or her preferences, by conveying content in the voice of historical and neighborhood characters, and by providing helpful information accessible from anywhere.

While BeyondGuide™ delivers facts, figures and information, one feature that makes the present invention particularly exciting is the exceptional experience it offers travelers. The personal tour guides (e.g., on the telephone) are engaging and eclectic—important historical figures or insignificant bystanders who witnessed important moments in history, comedians, criminals, restaurateurs and long-time residents.

The content is rich and unique, often communicated through interviews, musings and reenactments. Imagine visiting Washington, D.C., and experiencing the following: 1) standing on the steps of the Lincoln Memorial to hear Dr. Martin Luther King's “I Have a Dream” speech; 2) visiting the former Howard Johnson's Motel and hearing G. Gordon Liddy describe the Watergate break-in; 3) “bumping into” a lifelong Capitol Hill resident who personally recounts what the city was like when the worst traffic was horses and carriages. In an embodiment of the present invention, the audio content is of the highest quality, produced with professional voice talent, music and sound effects, allowing BeyondGuide™ to reenact or playback speeches and events (e.g., the chaos at Ford's Theater the night Lincoln was shot).

The present invention provides each customer with control. Users visit attractions in any order, at their own pace, controlling the type and amount of information they receive. The present invention also includes “custom-design” of tours for its users. Like a companion, the present invention learns more about travelers as they use the service—understanding their preferences for information, and how and when they want it delivered.

All types of content are tailored to each user, based on such selections as the following: 1) expressed preferences for depth and genre of content, types of sites and activities that are appealing, etc.; 2) previous interactions with the system (i.e., behavior); 3) what's going on right now (time of day, weather, current events); and 4) where the user is physically located.

The following scenario illustrates how this intense individualization of content dramatically improves a traveler's experience.

Imagine that you are visiting Washington, D.C. As you stroll toward the White House from your hotel, BeyondGuide™ begins to talk to you about the mansion's history and its humble beginnings. Along the way, BeyondGuide™ asked about your interests. You mentioned that you're an architecture buff and would like more information on that subject. As a result, you learn about the Greek influences on the White House's elaborate colonnade, as well as Pierre L'Enfant's reasoning for situating the White House where it is within the Capital City. You don't need to listen to information that doesn't interest you. Since you've never selected optional content about gardens and horticulture, the system has deduced that you don't care about this subject and stops offering it.

BeyondGuide™ suggests that you might want to spend the afternoon visiting indoor attractions, since a storm is on its way into the area. BeyondGuide™ recommends the new exhibit on Colonial Architecture at the Smithsonian American History Museum and provides you with the shortest route to get there. On the way back to your hotel, BeyondGuide™ helps you purchase tickets to the hottest play at the National Theater.

Embodiments of the present invention include the following types of content:

Point of interest information. A point of interest (POI) is an attraction visited by travelers for its historical, aesthetic, natural or cultural appeal. POIs include landmarks, buildings, gardens, castles, fountains, fortresses, memorials, wildlife wonders, statues, religious monuments, museums and other compelling places. POI information is the “story” that describes the POI and its historical, cultural or social significance.

Classification. BeyondGuide™ classifies POIs according to their level of appeal. In on embodiment, deeper, richer content is generated for the most visited locations (A-POIs). In an embodiment of the present invention, POIs are grouped into four categories: 1) A-POIs are “must see” landmarks, such as the White House; 2) B-POIs are secondary attractions, such as the Iwo Jima Memorial or the National Archives, which are significant, but not as popular; 3) C-POIs are minor points of interest, such as Einstein's Statue or St. John's Church in Washington, D.C.; and 4) T-POIs are special—they are places, such as the Watergate Hotel, that would not be attractions except for a particular story associated with them; in an embodiment of the present invention, T-POIs are covered only as a part of thematic tours, as described further below.

All POIs include a description of the physical location of the appearance of the POI so travelers may orient themselves. A, B and C-POIs each include a general description and overview of the POI. In addition, detailed audio segments about particular historical, cultural or social properties of the POI, are grouped into user affinities (e.g., art, history, movies, politics, business). The present invention uses these affinity segments to personalize each user's experience. A-POIs have many affinity segments (as many as ten); C-POIs often have none.

Thematic Information. A theme serves as a “window” on a specific set of POIs, uniting them with a single perspective. When a user visits a POI on a thematic tour, the user is presented with the site's theme story first; additional information can be accessed subsequently. Some POIs are only visited in conjunction with a theme (T-POIs). POIs included in a thematic tour may be visited in a recommended order or in any order at the traveler's option.

The present invention includes certain themes in some cities, such as the following: 1) historical tours; 2) political tours; 3) architectural tours; 4) ethnic/cultural tours; 5) scandals and scoundrels tours; 6) night tours; and 7) art-lover tours. Other tours are only appropriate in some places, such as the following: 1) Civil War tour; 2) Underground Railroad tour; 3) Vineyard tour; 4) French Quarter Jazz tour; 5) Mobster tour; and 6) Religious tour.

Convenience Services (Commodity Information). In order to offer a complete portfolio of travel information resources, the present invention delivers general city information and uses this information to customize the user experience. This information assists users with, for example, finding places to go, understanding how to get there, and making the most of their trips. Such information includes the following: 1) directions and maps; 2) restaurants and nightlife; 3) shopping; 4) current events; 5) weather; 6) event listings and tickets; 7) public services (e.g., transportation, embassies); and 8) airlines, hotels and car rental.

User Support. Embodiments of the present invention include a live customer service center, such as a call center. This customer center provides the human voice at the end of the line for travelers that require technical assistance or find themselves hopelessly lost in an unfamiliar city.

The customer center also answers content-related questions for travelers that are visiting a particular POI and want to know more. By answering users' questions with a real person, the present invention provides every component of value that a live guide does—and much more. The present invention includes a database for customer service representatives to use in answering these questions and accumulates frequently asked questions in a continually or regularly updated database.

Multilingual & Multicultural Support. The present invention supports multiple languages and variations in information provided based on cultural preferences of the user. The present invention considers not only linguistic differences, but also includes content tailored to cultural nuances specific to different cultures. For instance, a Christian tour of Jerusalem may be very different than a tour created for Jews visiting the same sites.

Pre-Trip & Post-Trip Services. The present invention provides a set of pre- and post-trip services to support tour use by users. These services are delivered via, for example, a network, such as the Internet, or other platforms. For example, before a trip, a Web site provides travelers with an orientation to the BeyondGuide™ experience and a vehicle for planning and researching their trips. Pre-trip services include: 1) a “sneak preview” of BeyondGuide™ cities and sights, including information about a destination's culture, customs, currency and weather; links to partner sites to help users make travel plans; and resources for family activities; and 2) pre-visit planning, including researching and selecting POIs and building an itinerary; selecting tour preferences; and recording personal affinities for tour customization. Travelers are also able to purchase services directly from the Web site.

After a trip, the Web site serves as a way for customers to relive their trip and plan subsequent travel. Post-trip services include the following: 1) an automatic travel log, including a diary of places visited to be printed and saved as a keepsake; 2) bookmark access, so travelers can refer back to interesting places they visited during their live tours; 3) value-added services delivered via partners (e.g., creating an electronic photo album of the trip); and 4) access to a BeyondGuide™ newsletter, with travel tips and notes.

The customer center also provides the following services: 1) answer general questions about BeyondGuide™; 2) address technical support issues related to the service; 3) handle user identification (ID) and password problems; 4) provide certain kinds of support for sales channels; 5) direct lost travelers; and 6) sell the service directly to users. In one embodiment, telephone customer support is available whenever tours are offered.

### BeyondGuide™ Information Delivery Framework

An example of the framework for delivery of services, in accordance with an embodiment of the present invention will now be described.

1. Information delivery occurs in one of two modes:

Push—information is delivered to the user based on the application flow, typically after the user has successfully provided to the system a response to WAY. From a user perspective, this is an implicit request for information.

Pull—information is delivered after the user has selected it from a menu of choices. From a user perspective, this is an explicit request for information.

2. Generic (no theme selected) scheme of information delivery:

A. First visit to a POI

Push mode—Level 0 (orientation) script followed by level 1 (overview) script.

Exceptions:

If either level 0 script or level 1 script, is not available—return the one that is available.

If both level 0 script and level 1 scripts are not available—go directly to pull mode.

Pull mode—Level 2 (detailed, focused) scripts, delivered one at a time, after a selection from the menu. Scripts are not offered more than once in subsequent menus at the current POI (i.e., used scripts).

Order of menu items: visitor information script at the bottom of the list; other scripts are not ordered.

B. Repeated visit to a POI

A repeated visit to a POI is a POI instance that has an identical POI_ID, an identical Session_ID, an identical personal identification number (PIN) for the user/session, and a used level-0 Script_ID in the Use_Log.

Information during a repeated visit to a POI is offered in pull mode only. The initial offering menu includes all the available scripts, including level-1 and level-2, but excluding level 0 (orientation) script.

Subsequent menus eliminate used scripts.

3. Thematic scheme of information delivery

A user can select one theme at the beginning of the session;

A user can change the selected theme at any point during the session; and

After selecting a theme, or changing a theme, the system “pushes” a thematic introductory script.

A. First visit to a POI

Push mode—Level 0 (orientation) script followed by a thematic script (L2) that matches the selected theme.

Pull mode—Level 1 (overview) script, and all available level 2 scripts, delivered one at a time, after selection from the menu. Scripts are not offered more than once.

Order of menu items: overview (L1) at the top, visitor information script at the bottom of the list, other scripts are not ordered.

B. Repeated visit to a POI

Same as 3.A above.

4. Recommended POIs

Three factors are considered for recommendations:

a) Geo-positioning (e.g., distance from current POI)

b) User's session history

c) Selected theme, if any

One, two, or three core POIs (only those that have information scripts) are used for composition of recommendations.

The list of recommended POIs excludes previously visited POIs within the current session.

Initially recommended POIs are within ½ a mile from the current POI (distance is calculated “as the crow flies”). If no POIs are found within the half-mile radius, the range is increased to one mile, and possibly to two miles.

If no recommended POIs can be generated within the greater range, or if the geo-position of the user is unknown, three random, non-previously visited POIs that match the selected theme are recommended. If the user has not selected a theme, the default theme is used.

Calculations of distances are performed in real-time.

Recommended POIs are required in four scenarios:

a) The user is at a POI for which BeyondGuide™ does not have information scripts. BeyondGuide™ may or may not have geo coordinates for non-core POIs. If coordinates are not available, recommended POIs are based on session history and theme.

b) The user chooses to continue the tour before exhausting all the available information.

c) The user has heard all the scripts for the current POI.

d) After the user selects or changes a theme.

Theme (a.k.a custom tour) selection. Users are presented with a selection of themes at the beginning of the session. Users may select one of the three current themes or none.

At any point during the session, users can go to the theme selection (by saying BeyondGuide™) and re-select a theme.

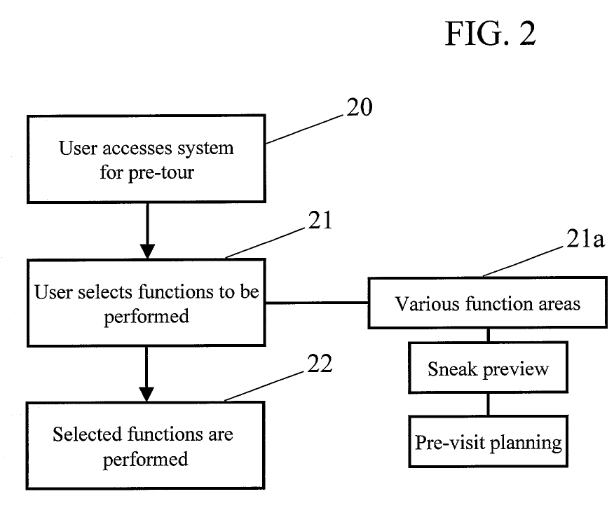

FIG. 2 is a flow diagram of a method of providing pre-tour interactive information, in accordance with an embodiment of the present invention.

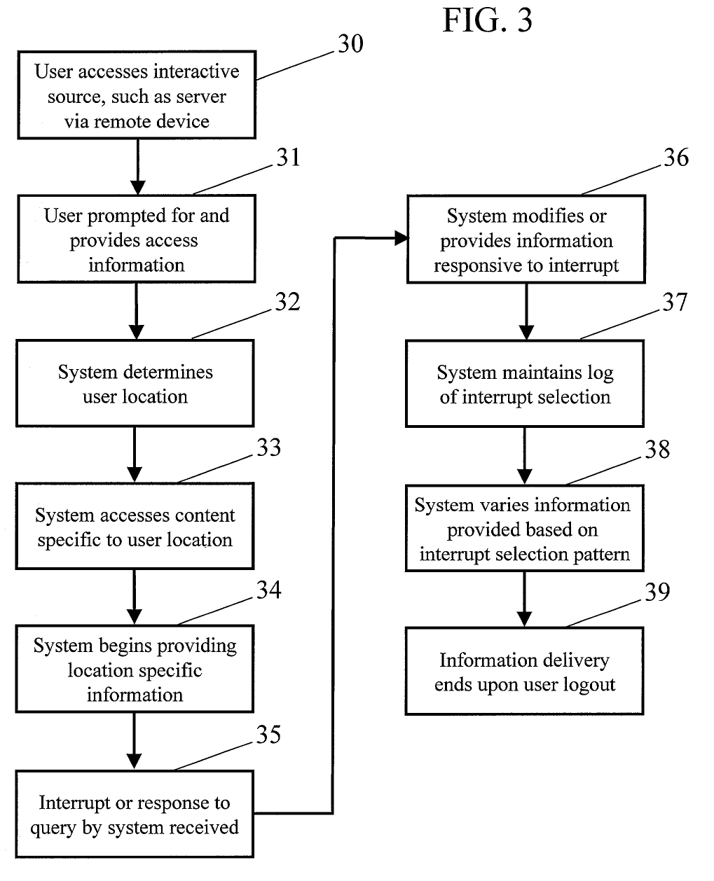

FIG. 3 is a flow diagram of a method of providing interactive information during a tour, in accordance with an embodiment of the present invention.

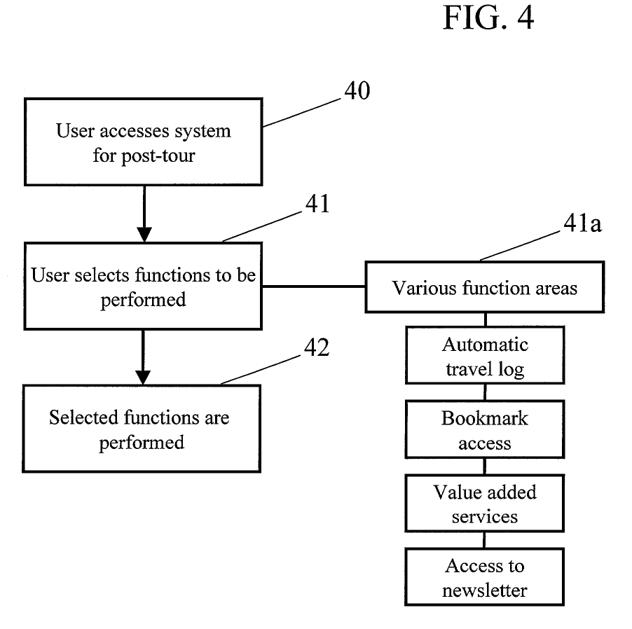

FIG. 4 is a flow diagram of a method of providing post-tour interactive information, in accordance with an embodiment of the present invention.

Example embodiments of the present invention have now been described in accordance with the above advantages. It will be appreciated that these examples are merely illustrative of the invention. Many variations and modifications will be apparent to those skilled in the art.

What is claimed is:

1. A method for providing interactive information to a remote user, the method comprising:
receiving access information from the remote user;
determining a location of interest for the remote user; and
providing the interactive information to the user.

2. The method of claim 1, wherein the remote user receives access information via a remote device.

3. The method of claim 2, wherein the remote devices is selected from a group consisting of a telephone, a personal data assistant, a terminal having high bandwidth communication capability, and a terminal having low bandwidth communication capability.

4. The method of claim 3, wherein the terminal is selected from a group consisting of a personal computer, a minicomputer, a microcomputer, and a main frame computer.

5. The method of claim 3, wherein the telephone is a cellular telephone.

6. The method of claim 1, wherein the location of interest is determined using geographical positioning system information.

7. The method of claim 1, wherein the location of interest is determined using cellular telephone triangulation.

8. The method fo claim 1, wherein determining a location of interest includes:
receiving input of location information.

9. The method of claim 1, wherein the location of interest is determined using network based location information.

10. The method of claim 1, wherein the interactive information includes guided tour information.

11. The method of claim 1, wherein the interactive information is provided using automation.

12. The method of claim 1, wherein the interactive information is provided using voice response.

13. The method of claim 1, wherein the interactive information is provided in response to receiving keyed input.

14. The method of claim 1, wherein the interactive information includes audio information.

15. The method of claim 1, wherein the interactive information includes multimedia information.

16. The method of claim 1, further comprising:
providing an option for contacting a call center.

17. The method of claim 1, wherein providing the interactive information includes:
receiving at least one request for information; and
providing information responsive to the at least one request.

18. The method of claim 17, wherein the request for information includes geographical location information.

19. The method of claim 18, wherein the information responsive to the at least one request is tailored to the geographical location information.

20. The method of claim 17, further comprising:
providing options for a plurality of information types.

21. The method of claim 20, wherein the plurality of information types are selected from a group consisting of directions, hot spots, and location information.

22. The method of claim 20, wherein the plurality of information types are selected from a group consisting of entertaining facts, anecdotes, reenactments of historic events, and personal accounts.

23. The method of claim 20, further comprising:
analyzing a plurality of the at least one request for information to determine a preferred information type, the preferred information type being selected from the plurality of information types; and
providing the information responsive to the at least one request, the responsive information being of the preferred information type.

24. The method of claim 1, further comprising:
providing an option to obtain pre-tour information.

25. The method of claim 1, further comprising:
providing an option to obtain post-tour information.

26. A system for providing interactive information, the system comprising:
a server housing an information delivery engine, the server being coupled to a network;
a remote device coupleable to the network; and
a position determination component coupled to the server for obtaining location information from the remote device and transmitting the location information to the server;
wherein interactive information is delivered from the server to the remote device via the network, the interactive information varying depending on the location information obtained from the remote device.

27. The system of claim 26, wherein the network is a publicly owned telephone system.

28. The system of claim 26, wherein the network is a cellular telephone network.

29. The system of claim 26, wherein the network is the internet.

30. The system of claim 26, wherein the server is selected from a group consisting of a personal computer, a main frame computer, a minicomputer, and a microcomputer.

31. The system of claim 26, wherein the server includes a repository.

32. The system of claim 31, wherein the repository comprises a database.

33. The system of claim 31, wherein the server is coupled to a repository.

34. The system of claim 26, wherein the remote devices is selected from a group consisting of a telephone, a personal data assistant, a terminal having high bandwidth communication capability, and a terminal having low bandwidth communication capability.

35. The system of claim 26, wherein the server includes content handling software.

36. The system fo claim 26, further comprising:
at least one content provider server coupled to the network;
wherein content information is transmitted from the at least one content handling server to the server.

37. The system of claim 26, further comprising:
a support center coupleable to the remote device.

38. The system of claim 37, wherein the support center is coupleable to the remote device via the network.

39. A system for providing interactive information to a remote user, the system comprising:
means for receiving access information from the remote user;
means for determining a location of interest for the remote user; and
means for providing the interactive information to the user.
